(19) United States
(12) Patent Application Publication
(10) Pub. No.: US 2006/0024471 A1
(43) Pub. Date: Feb. 2, 2006

(54) Weighted-edge overlay article

(76) Inventor: Dawn Cunningham, Hermitage, TN (US)

Correspondence Address: CALFEE HALTER & GRISWOLD, LLP, 800 SUPERIOR AVENUE, SUITE 1400, CLEVELAND, OH, 44114, US

(21) Appl. No.: 10/900,748

(22) Filed: Jul. 28, 2004

(51) Int. Cl. B32B 3/02

(52) U.S. Cl. 428/81

(57) ABSTRACT

An overlay article for overlaying an object surface is provided. In one embodiment, the overlay article includes: a first material panel and at least one weighted portion. The first material panel has a lower surface and an upper surface that define a perimeter region. Each weighted portion is disposed along the perimeter region. Each weighted portion is a closed cavity formed by securing a second material panel to the upper surface of the first material panel to hold a weighted material captive between the first and second material panels during normal use and maintenance of the overlay article. The weighted material is resistant to absorption of water, resistant to corrosion, and resistant to staining the first and second material panels. In another embodiment, the weighted material may be polyethylene or polyvinylchloride pellets. The overlay article may, for example, be a beach towel or a beach blanket.

### BACKGROUND

The exemplary embodiments described herein relate to a weighted-edge overlay article. They find particular application in conjunction with a weighted-edge beach towel, and will be described with particular reference thereto. However, it is to be appreciated that the present exemplary embodiments are also amenable to other like applications. For example, various types of towels, blankets, tablecloths, mats, rugs, and covers.

It has been recognized that various types of standard overlay articles are not well-suited for windy or drafty environments because they tend to be moved by wind or drafts. For example, beach towels, beach blankets, picnic blankets, tablecloths, mats, rugs, covers, and other types of overlays may blow away, fold over, or wrinkle up when exposed to wind. Overlay articles of various designs and configurations heretofore devised and utilized for the purpose of retaining the article in a desired location while under the force of wind are known to employ securing the article with stakes, placing weighted objects on the article, embedding cord or chain in the perimeter of the article, or adding sand to pockets along the perimeter of the article. Several examples of U.S. patents that disclose these techniques are identified below.

U.S. Pat. No. 6,721,973 to Cristiano discloses a beach blanket that includes a panel member that has an upper surface and lower surface. The lower surface is for resting on a beach. The panel member has a plurality of anchor pockets. Each of the anchor pockets are positioned proximate a perimeter edge of the panel member. Each of the anchor pockets is for receiving some of the sand from the beach such that the anchor pockets anchor the panel member to the beach when the anchor pockets have some of the sand within the anchor pockets.

U.S. Pat. No. 5,465,458 to Schlager discloses a retainer for placing on towels, garments, papers, and the like to, for example, secure them to the ground. The retainer includes two or more weight members spaced or separated by a generally flexible elongated connector which joins them together. Preferably, the weight members are sac-like or pouch-like receptacles filled with loose pellets and connected together by a nylon strap or webbing.

U.S. Pat. No. 5,141,200 to Sherman et al. discloses a blanket hold down device that is formed from two plies of fabric stitched together about their edges with an open portion secured together by detachable closure elements to facilitate the insertion and removal of weighting material. A strap is provided on one surface of the hold down device for engaging and holding a corner of a blanket or the like. An apertured tab is also secured to an edge of the hold down device for the reception of a hold down stake.

U.S. Pat. No. 4,910,855 to Balarzs discloses a blanketwith a weighted perimeter. The weighted perimeter is provided by sewing a chain into the hem at the perimeter of the blanket.

U.S. Pat. No. 4,634,618 to Greer et al. discloses a beach towel or picnic blanket with a hidden weighted cord sewn into the perimeter to hold the item secure in the wind.

However, a weighted-edge overlay article that is self-contained, washable, and easily manufactured from standard, inexpensive materials without requiring subsequent addition or removal of weighting material has not been previously disclosed.

### BRIEF DESCRIPTION

In accordance with an exemplary embodiment, a weighted-edge overlay article for overlaying at least a portion of an associated object surface includes: a flexible first material panel having a lower surface and an upper surface that define a shape for the overlay article and a corresponding perimeter region and at least one weighted portion disposed along at least a portion of the perimeter region of the overlay article to aid in retaining the overlay article in a desired location when the overlay article is exposed to a windy environment while overlaying the associated object surface. The lower surface rests on the associated object surface during at least a portion of normal use of the overlay article. Each weighted portion is a closed cavity formed by securing a flexible second material panel to the upper surface of the first material panel to hold a corresponding weighted material captive between the first and second material panels during normal use and maintenance of the overlay article. The weighted material is resistant to absorption of water, resistant to corrosion when exposed to water, and resistant to staining the first and second material panels when exposed to water.

In accordance with another exemplary embodiment, a flexible, generally rectangular overlay article for overlaying at least a portion of a surface of an associated object includes: a flexible generally rectangular first material panel having a lower surface and an upper surface that define the generally rectangular shape for the overlay article and a corresponding perimeter region and four or more weighted portions displaced from each other and disposed along at least a portion of the perimeter region of the overlay article to aid in retaining the overlay article in a desired location in relation to the associated object when the overlay article is exposed to a windy environment. Each weighted portion including a flexible second material panel and a plurality of plastic pellets. Each weighted portion is a closed cavity formed by sewing the second material panel to the upper surface of the first material panel to securely hold the plurality of plastic pellets captive between the first and second material panels during normal use and maintenance of the overlay article. The plastic pellets are resistant to absorption of water, resistant to corrosion when exposed to water, and resistant to staining the first and second material panels when exposed to water.

In accordance with yet another exemplary embodiment, a flexible, generally rectangular weighted-edge overlay article for overlaying at least a portion of an associated object surface includes: a flexible generally rectangular first material panel having a lower surface and an upper surface that define the generally rectangular shape for the overlay article and a corresponding perimeter region, wherein the lower surface rests on the associated object surface during at least a portion of normal use of the overlay article and four or more weighted portions displaced from each other and disposed along the perimeter region of the overlay article to aid in retaining the overlay article in a desired location when the overlay article is exposed to a windy environment while overlaying the associated object surface. Each weighted portion including a flexible second material panel, a flexible container, and a plurality of plastic pellets. Each corresponding flexible container is closed up to securely hold the corresponding weighted material captive therein during normal use and maintenance of the overlay article. Each weighted portion is a closed cavity formed by sewing the second material panel to the upper surface of the first material panel to securely hold the flexible container captive between the first and second material panels during normal use and maintenance of the overlay article. The plastic pellets are resistant to absorption of water, resistant to corrosion when exposed to water, and resistant to staining the first and second material panels when exposed to water.

Further scope of the applicability of the present exemplary embodiment will become apparent from the detailed description provided below. It should be understood, however, that the detailed description and specific examples, while indicating exemplary embodiments, are given by way of illustration only, since various changes and modifications within the spirit and scope of the exemplary embodiments will become apparent to those skilled in the art.

### BRIEF DESCRIPTION OF THE DRAWINGS

The exemplary embodiments exist in the construction, arrangement, and combination of the various parts of the weighted-edge overlay article, whereby the objects contemplated are attained as hereinafter more fully set forth, specifically pointed out in the claims, and illustrated in the accompanying drawings in which:

FIG. 1 is an exemplary embodiment of a weighted-edge overlay article incorporating one or more aspects of the invention;

FIG. 2 is a cross-section of an exemplary embodiment of a weighted portion the weighted-edge overlay article of FIG. 1;

FIG. 3 is a cross-section of another exemplary embodiment of a weighted portion the weighted-edge overlay article of FIG. 1; and

FIG. 4 is another exemplary embodiment of a weighted-edge overlay article incorporating one or more aspects of the invention.

### DETAILED DESCRIPTION

In the case of the weighted-edge overlay article, the primary benefits provided by the product include, but are not limited to, providing consumers with an overlay article, such as a beach towel, that stays flat, regardless of wind. In one embodiment, the weighted-edge overlay article has non-toxic weights sewn into the edges. This eliminates the need to place shoes, bags, or other items on the corners of a beach towel to keep it from being disturbed by the wind. The weighted-edge overlay article is easy to wash and dry. The weighted-edge overlay article is not likely to cause injury if someone accidentally is hit with a weighted edge. The weighted-edge overlay article is easy to use and affordable.

The weighted-edge overlay article is a simple and effective product designed, for example, in one embodiment, as a beach towel with non-toxic plastic pellets sewn into each corner. The product is weighted to stay flat on the ground regardless of wind. The product is fully washable.

There are various types of weighted-edge overlay articles, such as beach towels, beach blankets, picnic blankets, tablecloths, mats, rugs, covers, and other types of towels, blankets, and overlays. A weighted-edge beach towel, for example, may be produced in a range of sizes such as regular, over-sized, and beach blanket size.

In one embodiment, the product consists of nylon triangular pouches or flexible containers filled with non-toxic plastic pellets. The pouches, for example, may weigh one and one-half to two pounds although lighter or heavier pouches may also be implemented. In one embodiment, the pouches are sewn into triangular pockets or closed cavities in corners of the overlay article. The weighted-edge overlay article may be made from any suitable fabric or other material. A weighted-edge beach towel, for example, may be made from standard terry cloth material in a wide range of colors and patterns. Due to the relatively simple materials making up the weighted-edge overlay article, it should be relatively easy to produce from a technical standpoint and existing assembly lines could be easily adapted for its manufacture.

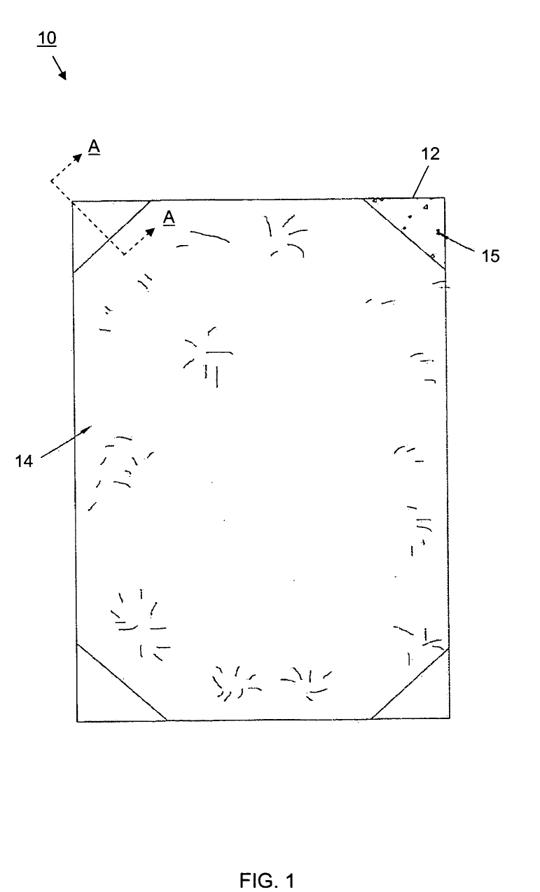

Referring now to the drawings, wherein the showings are for purposes of illustrating the exemplary embodiments only and not for purposes of limiting same, FIG. 1 provides a view of an exemplary embodiment of a weighted-edge overlay article 10. The weighted-edge overlay article 10 is generally rectangular in shape and includes four generally triangular-shaped weighted portions 12 and a generally rectangular-shaped first material panel 14. In other embodiments, the shape of the overlay article may be square, circular, triangular, any other suitable geometric shape, or any other suitable custom shape. The shape of the overlay article may be symmetrical or asymmetrical. In other embodiments, the shape of the weighted portions may also be any suitable shape. There may be more or less weighted portions and each weighted portion need not be the same size or shape.

The first material panel 14 includes a lower surface and an upper surface. The lower surface rests on at least a portion of an associated object surface, such as the ground (beach) or the surface of a table. The first material panel 14 may include a single ply or multiple ply fabric or another suitable material. Similarly, the weighted portion 12 includes a second material panel 15 which may also include a single ply or multiple ply fabric or another suitable material. The weighted portion 12 is a closed cavity formed by securing the second material panel 15 to the upper surface of the first material panel. In the embodiment shown, there is a separate second material panel 15 for each weighted portion 12. In this embodiment, the size and shape of the second material panel 15 is generally the same size and shape as the corresponding weighted portion 12.

For example, where the overlay article 10 is a beach towel, the fabric for the material panels may be a standard terry cloth material. However, the material panels need not include the same fabric or even the same type of fabric.

The weighted portions 12 also each include a weighted material. The second material panel 15 is secured to the upper surface of the first material panel 14 during manufacturing of the overlay article 10 so that the weighted material is held captive between the first and second material panels 14, 15. Typically, the first and second material panels 14, 15 are sewn together to hold the weighted material captive, although any suitable means of securing the material panels together is acceptable. The means for securing the material panels together should not permit release of the captive weighted material during normal use or maintenance of the overlay article.

Normal use of the overlay article 10 includes, for example, when the overlay article is overlaying at least a portion of an associated object surface and the lower surface of the first material panel 14 is resting on the associated object surface. Of course, a user may also use the overlay article 10 in an upside down configuration with the upper surface resting on the associated object surface. Maintenance of the overlay article may include washing and drying in washer and dryer machines or using manual washing and drying techniques.

The weighted material is resistant to absorption of water or similar liquids. The weighted material is also resistant to corrosion and resistant to staining the first and second material panels 14, 15 when exposed to water or similar liquids. It is understood that the weighted material may become released from its captive position if the securing means or fabric is destroyed or becomes worn. If the weighted material is released, it can be returned to its captive position and the overlay article can be repaired so that it is again held captive within the corresponding weighted portion.

In one embodiment, the first and second material panels 14, 15 may correspond to first and second plies of a multiple ply material. In this embodiment, the weighted material may be inserted between the plies of the multiple ply material and the weighted portion 12 may be formed by securing the multiple plies together around the weighted material to hold it captive in a desired area of the overlay article 10. In this embodiment, the first and second material panels 14, 15 are generally the same size and shape.

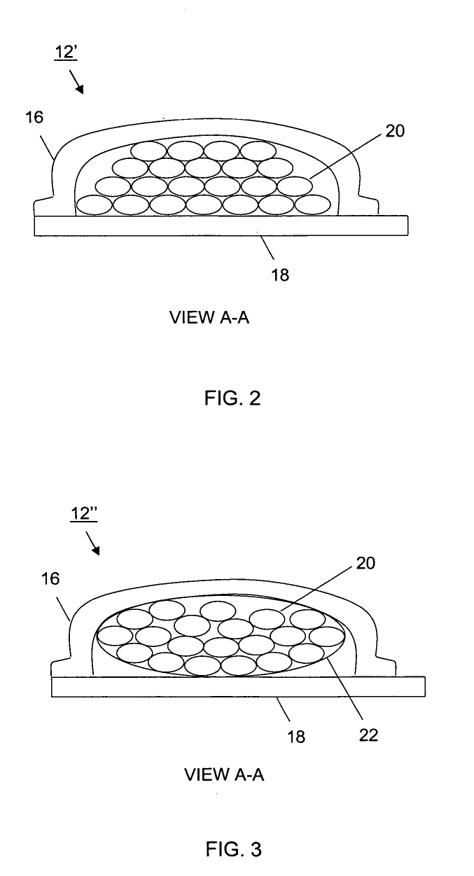

With reference to FIG. 2, an exemplary embodiment of the weighted portion 12′ is shown in cross-section. The weighted portion 12′ includes an upper panel member 16, a lower panel member 18, and the weighted material 20. The upper and lower panel members 16, 18 are secured together around the weighted material 20 to hold it captive during manufacturing. Typically, the upper and lower panel members 16, 18 are sewn together, although any suitable means of securing the upper and lower panel members 16, 18 together to hold the weighted material 20 captive is acceptable. The means for securing the two fabrics together should not permit release of the captive weighted material 20 during normal use or maintenance of the overlay article. It is understood that the weighted material 20 may become released from its captive position if the securing means or one of the upper or lower members 16, 18 is destroyed or becomes worn. If the weighted material 20 is released, it can be returned to its captive position and the overlay article can be repaired so that the weighted material 20 is again held captive within the corresponding weighted portion. The upper and lower panel members 16, 18 are the fabric or another suitable material included in the overlay article 10 and described above in conjunction with FIG. 1.

The weighted material 20 is depicted as a plurality of plastic pellets, but may be any suitable material. Any material that is suitable for machine washing and machine drying may be used for the weighted material 20. To be suitable for machine washing and drying, for example, the weighted material should be resistant to absorption of water, resistant to corrosion when exposed to water, and resistant to staining the upper and lower members 16, 18 when exposed to water. If plastic pellets are used, the plastic pellets may be polyethylene (PE) or polyvinylchloride (PVC) such as those used by Ty Inc. of Oakbrook, Ill. in Beanie Babies® and other products. PE pellets are preferred because they are considered non-toxic.

With reference to FIG. 3, another exemplary embodiment of the weighted portion 12″ is shown in cross-section. The weighted portion 12″ includes the upper panel member 16, lower panel member 18, weighted material 20, and a flexible container 22. Any openings or panels associated with the flexible container 22 are securely closed up during manufacturing to hold the weighted material 20 captive. The flexible container 22 may be securely closed up by sewing multiple panels together, by sewing one or more openings shut, or by any other suitable means. The upper and lower panel members 16, 18 are secured together around the flexible container 22 to hold it captive during manufacturing. Typically, the upper and lower panel members 16, 18 are sewn together, although any suitable means of securing the upper and lower panel members 16, 18 together to hold the flexible container 22 captive is acceptable. The means for securing the two fabrics together should not permit release of the captive flexible container 22 during normal use or maintenance of the overlay article. It is understood that the flexible container 22 may become released from its captive position if the securing means or one of the upper or lower members 16, 18 is destroyed or becomes worn. If the flexible container 22 is released, it can be returned to its captive position and the overlay article can be repaired so that the flexible container 22 is again held captive within the corresponding weighted portion. The upper and lower panel members 16, 18 are the fabric or another suitable material included in the overlay article 10 and described above in conjunction with FIG. 1.

The flexible container 22 may be a single ply or multiple ply fabric or another suitable material. The material used for the flexible container 22 may be different from the material used for the upper and lower panel members 16, 18. Typically, the panels or openings associated with the flexible container 22 are sewn together, although any suitable means of securely closing the flexible container 22 to hold the weighted material 20 captive is acceptable. The means for securing the flexible container 22 should not permit release of the captive weighted material 20 during normal use or maintenance of the overlay article. It is understood that the weighted material 20 may become released from its captive position if the securing means or the flexible container 22 is destroyed or becomes worn. If the weighted material 20 is released, it can be returned to its captive position and the overlay article can be repaired so that the weighted material 20 is again held captive within the flexible container 22.

The weighted material 20 may be plastic pellets or another suitable material as described above in conjunction with FIG. 2.

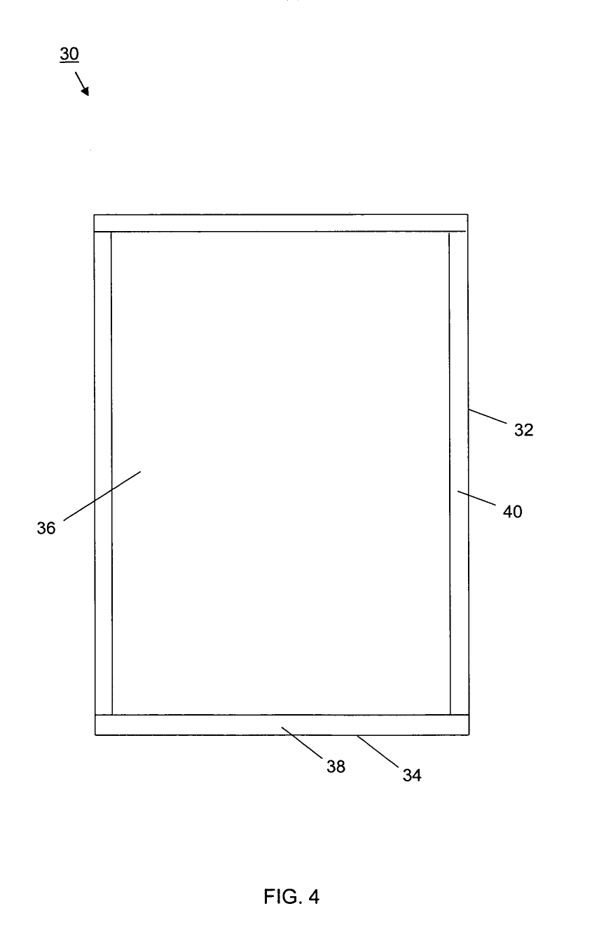

With reference to FIG. 4, another exemplary embodiment of a rectangular weighted-edge overlay article 30 includes two rectangular-shaped weighted portions 32 along the length of the overlay article, two rectangular-shaped weighted portions 34 along the width of the overlay article, and a first material panel 36. In other embodiments, the shape of the overlay article may be square, circular, triangular, any other suitable geometric shape, or any other suitable custom shape. The shape of the overlay article may be symmetrical or asymmetrical. In other embodiments, the shape of the weighted portions may also be any suitable size and shape. There may be more or less weighted portions and each weighted portion may be the same size and shape, different sizes, or different shapes. For example, the weighted portions along the length may be removed in one embodiment leaving only two weighted portions along the width. In another exemplary embodiment, a single, contiguous weighted portion may be provided along the perimeter of the overlay article.

The weighted portions 32 along the length of the overlay article include a second material panel 38 and the weighted portions 34 along the width of the overlay article include a third material panel 40. The first, second, and third material panels 36, 38, 40 may include the same types of fabrics or other suitable materials as those described above in conjunction with the overlay article 10 of FIG. 1. In other words, the first, second, and third material panels 36, 38, 40 may include the same materials or any combination of different materials. As with the weighted portions 12 of FIG. 1, the weighted portions 32, 34 each include a weighted material. The second and third material panels 38, 40 associated with the weighted portions 32, 34 are secured to the first material panel 36 during manufacturing so that the weighted material is held captive between the material panels 36, 38, 40 corresponding to the respective weighted portions 32, 34. Typically, the corresponding material panels 36, 38 or 36, 40 are sewn together, although any suitable means of securing the material panels together to hold the corresponding weighted material captive is acceptable. The means for securing the material panels together should not permit release of the captive weighted material during normal use or maintenance of the overlay article. Maintenance of the overlay article may include washing and drying in washer and dryer machines. It is understood that the weighted material may become released from its captive position if the securing means or fabric is destroyed or becomes worn. If the weighted material is released, it can be returned to its captive position and the overlay article can be repaired so that it is again held captive within the corresponding weighted portion.

The weighted portion 32, 34 may include the same components and materials depicted in the cross-section of weighted portions 12′, 12″ of FIGS. 2 and 3 and described above.

The exemplary embodiments have been described above with reference to the drawing and various types of overlay articles. Obviously, modifications and alternations will occur to others upon reading and understanding the preceding detailed description. It is intended that the exemplary embodiments be construed as including all such modifications and alterations insofar as they come within the scope of the appended claims or the equivalents thereof.

1. A weighted-edge overlay article for overlaying at least a portion of an associated object surface, including:
a flexible first material panel having a lower surface and an upper surface that define a shape for the overlay article and a corresponding perimeter region, wherein the lower surface rests on the associated object surface during at least a portion of normal use of the overlay article; and
at least one weighted portion disposed along at least a portion of the perimeter region of the overlay article to aid in retaining the overlay article in a desired location when the overlay article is exposed to a windy environment while overlaying the associated object surface;
wherein each weighted portion is a closed cavity formed by securing a flexible second material panel to the upper surface of the first material panel to hold a corresponding weighted material captive between the first and second material panels during normal use and maintenance of the overlay article; and
wherein the weighted material is resistant to absorption of water, resistant to corrosion when exposed to water, and resistant to staining the first and second material panels when exposed to water.

2. The overlay article set forth in claim 1 wherein the second material panel is sewn to the first material panel to form the corresponding closed cavity holding the corresponding weighted material captive for each weighted portion.

3. The overlay article set forth in claim 1 wherein the weighted material in at least one weighted portion is held captive within a flexible container, the first and second material panels being secured to hold the flexible container captive within the weighted portion during normal use and maintenance of the overlay article.

4. The overlay article set forth in claim 1 wherein the weighted material includes plastic pellets.

5. The overlay article set forth in claim 4 wherein the plastic pellets are one of polyethylene pellets and polyvinylchloride pellets.

6. The overlay article set forth in claim 1 wherein the overlay article is one of a towel, a blanket, a tablecloth, a mat, a rug, and a cover.

7. The overlay article set forth in claim 1 wherein there is a separate second material panel for each weighted portion and the size and shape of the second material panel is related to the size and shape of the corresponding weighted portion.

8. The overlay article set forth in claim 1 wherein the first and second material panels correspond to first and second plies of a multiple ply material and the size and shape of the second material panel is related to the size and shape of the first material panel.

9. The overlay article set forth in claim 1 wherein the first material panel is generally shaped like a rectangle and at least one weighted portion is generally shaped like a triangle having a right angle relating to a corner of the first material panel.

10. The overlay article set forth in claim 9 wherein the first material panel is generally shaped like a rectangle with four corners and at least four weighted portions are generally shaped like triangles having generally right angles, the right angle of each triangular weighted portion relating to different corners of the first material panel.

11. The overlay article set forth in claim 1 wherein the first material panel is generally shaped like a first rectangle and at least one weighted portion is generally shaped like a second rectangle with a side of the rectangular weighted portion relating to a side of the first material panel.

12. The overlay article set forth in claim 11 wherein the first material panel is generally shaped like a first rectangle with a first pair of opposite sides and a second pair of opposite sides, at least two first weighted portions are generally shaped like a second rectangle with a side of each first rectangular weighted portion relating to different sides of the first pair of opposite sides of the first material panel, and at least two second weighted portions are generally shaped like a third rectangle with a side of each second rectangular weighted portion relating to different sides of the second pair of opposite sides of the first material panel.

13. A flexible, generally rectangular overlay article for overlaying at least a portion of a surface of an associated object, including:
a flexible generally rectangular first material panel having a lower surface and an upper surface that define the generally rectangular shape for the overlay article and a corresponding perimeter region; and
four or more weighted portions displaced from each other and disposed along at least a portion of the perimeter region of the overlay article to aid in retaining the overlay article in a desired location in relation to the associated object when the overlay article is exposed to a windy environment, each weighted portion including a flexible second material panel and a plurality of plastic pellets;
wherein each weighted portion is a closed cavity formed by sewing the second material panel to the upper surface of the first material panel to securely hold the plurality of plastic pellets captive between the first and second material panels during normal use and maintenance of the overlay article;
wherein the plastic pellets are resistant to absorption of water, resistant to corrosion when exposed to water, and resistant to staining the first and second material panels when exposed to water.

14. The overlay article set forth in claim 13 wherein the plastic pellets are polyethylene pellets.

15. The overlay article set forth in claim 13 wherein the plastic pellets are polyvinylchloride pellets.

16. The overlay article set forth in claim 13 wherein the overlay article is one or a beach towel and a beach blanket.

17. The overlay article set forth in claim 13 wherein the weighted portions are generally shaped like one of a triangle and a rectangle.

18. A flexible, generally rectangular weighted-edge overlay article for overlaying at least a portion of an associated object surface, including:
a flexible generally rectangular first material panel having a lower surface and an upper surface that define the generally rectangular shape for the overlay article and a corresponding perimeter region, wherein the lower surface rests on the associated object surface during at least a portion of normal use of the overlay article; and
four or more weighted portions displaced from each other and disposed along the perimeter region of the overlay article to aid in retaining the overlay article in a desired location when the overlay article is exposed to a windy environment while overlaying the associated object surface, each weighted portion including a flexible second material panel, a flexible container, and a plurality of plastic pellets;
wherein each corresponding flexible container is closed up to securely hold the corresponding weighted material captive therein during normal use and maintenance of the overlay article;
wherein each weighted portion is a closed cavity formed by sewing the second material panel to the upper surface of the first material panel to securely hold the flexible container captive between the first and second material panels during normal use and maintenance of the overlay article;
wherein the plastic pellets are resistant to absorption of water, resistant to corrosion when exposed to water, and resistant to staining the first and second material panels when exposed to water.

19. The overlay article set forth in claim 18 wherein the plastic pellets are one of polyethylene pellets and polyvinylchloride pellets.

20. The overlay article set forth in claim 19 wherein the overlay article is one of a towel, a blanket, a tablecloth, a mat, a rug, and a cover.
